(19) United States
(12) Patent Application Publication
(10) Pub. No.: US 2026/0121284 A1
(43) Pub. Date: Apr. 30, 2026

(54) VEHICULE ANTENNA DEVICE

(71) Applicant: HARADA INDUSTRY CO., LTD., Tokyo (JP)

(72) Inventor: Toshihiro IWATA, Shinagawa-ku, Tokyo (JP)

(21) Appl. No.: 19/482,617

(22) PCT Filed: May 8, 2024
(86) PCT No.: PCT/JP2024/017091

§ 371 Date: Nov. 7, 2025

(30) Foreign Application Priority Data
May 9, 2023 (JP) 2023-077216

(51) Int. Cl. H01Q 1/32; H01Q 1/42

(52) U.S. Cl. CPC H01Q 1/325; H01Q 1/42

(57) ABSTRACT

A vehicle antenna device to be fixed to a vehicle body is provided. The vehicle antenna device includes an antenna base having a resin base and a conductive base, an antenna case that is fixed to the antenna base and defines an internal space thereof together with the antenna base, an antenna element that is disposed within the internal space of the antenna case and has a feeding section, and a circuit board to which the feeding section of the antenna element is connected, the circuit board extending above the conductive base while being fixed thereto and further extending above the resin base, wherein, when the antenna base is fixed to the antenna case, at least a portion of the circuit board extended above the resin base is sandwiched between the resin base and the antenna case, to thereby fix the circuit board.

### CROSS-REFERENCE TO RELATED APPLICATIONS

This application is a U.S. national stage application of International Application No. PCT/JP2024/017091, filed on May 8, 2024. This application claims priority to Japanese Patent Application No. 2023-077216, filed on May 9, 2023.

### BACKGROUND

### Technical Field

The present invention relates to a vehicle antenna device, and more particularly to a vehicle antenna device that is fixed to a vehicle body and houses therein a circuit board.

### Background Information

As vehicle antenna devices configured to be fixed to a vehicle, those having an antenna element capable of receiving AM and FM broadcasts are generally used. There also exist compact and low-profile antenna devices such as so-called shark-fin antennas that house such an antenna element within an internal space. Further, as exemplified by electric vehicles and hybrid cars, weight reduction of vehicles has been promoted in view of fuel efficiency. Vehicle antenna devices are also required to be lightweight, and those having a resin base are being developed in place of those having a conductive base. For example, the invention of International Publication WO 2012/127903 (Patent Document 1) discloses a composite antenna base that combines the resin base and the conductive base.

### SUMMARY

An antenna base of a vehicle antenna device is provided with a circuit board fixed thereto, the circuit board carrying a connector for connecting to a feeding section of an antenna element and an amplifier circuit for amplifying a received signal from the antenna element. When the circuit board extends from the conductive base to a region above the resin base and is fixed to both the conductive base and the resin base, differences in thermal expansion between the two may subject the respective portions of the circuit board to unintended forces caused by thermal stress. Application of such thermal stress to the circuit board may cause the displacement of the connector on the circuit board, wiring disconnection, or cracking of the circuit board. For this reason, the circuit board size is restricted, limiting the layout, and the circuit board needs to be arranged on both the conductive base and the resin base.

Thus, a vehicle antenna device in which the circuit board on the antenna base is not subjected to unintended forces caused by thermal stress and in which the circuit board has reduced layout restrictions needs to be developed.

The present disclosure has been made in view of the above situation, and an object thereof is to provide a vehicle antenna device in which the circuit board on the antenna base is not subjected to unintended forces caused by thermal stress and in which the circuit board has reduced layout restrictions.

To achieve the above object of the present disclosure, a vehicle antenna device according to the present disclosure includes: an antenna base having a resin base and a conductive base; an antenna case that is fixed to the antenna base and defines an internal space thereof together with the antenna base; an antenna element that is disposed within the internal space of the antenna case and has a feeding section; and a circuit board to which the feeding section of the antenna element is connected, the circuit board extending above the conductive base while being fixed thereto and further extending above the resin base, wherein, when the antenna base is fixed to the antenna case, at least a portion of the circuit board extended above the resin base is sandwiched between the resin base and the antenna case, to thereby fix the circuit board.

The vehicle antenna device may further include a connection terminal that is disposed on a portion of the circuit board extended above the resin base of the antenna base and to which the feeding section of the antenna element is connected.

The antenna case may have a shark-fin shape, and the connection terminal may be disposed on a portion of the circuit board within the internal space adjacent to the leading end side that is located on the lower-height side of the shark-fin shape.

The vehicle antenna device may further include an amplifier circuit that is disposed on a portion of the circuit board extended above the conductive base of the antenna base.

The antenna element may be fixed to the antenna case.

The feeding section of the antenna element may be formed of a plate-like terminal having a plate-like flat portion, and a surface direction of the flat portion of the plate-like terminal may be oriented in the axial direction passing from the leading end side that is on the lower-height side of the shark-fin shape to the rear end thereof, and the connection terminal may be formed of a leaf spring terminal configured to hold a surface of the flat portion of the plate-like terminal.

The vehicle antenna device may further include a waterproof pad that is interposed between the antenna base and the antenna case so as to ensure waterproofness within the internal space, wherein the waterproof pad may be partially interposed both between the resin base and the circuit board and/or between the antenna case and the circuit board at a position where at least a portion of the circuit board is sandwiched between the resin base and the antenna case.

The vehicle antenna device according to the present disclosure is advantageous in that the circuit board on the antenna base is not subjected to unintended forces caused by thermal stress and that the circuit board has reduced layout restrictions.

### BRIEF DESCRIPTION OF THE DRAWINGS

Referring now to the attached drawings which form a part of this original disclosure, illustrative embodiments are shown.

FIG. 1 is a schematic exploded perspective view for explaining a vehicle antenna device according to the present disclosure.

FIG. 2 is a schematic enlarged cross-sectional side view for explaining details of the fixed portion of a circuit board included in the vehicle antenna device according to the present disclosure.

FIG. 3 is a schematic enlarged perspective view for explaining details of a feeding section of an antenna element and a connection terminal in the vehicle antenna device according to the present disclosure.

FIG. 4 is a schematic enlarged perspective view for explaining details of a waterproof pad of the vehicle antenna device according to the present disclosure.

FIG. 5 is a schematic enlarged cross-sectional side view corresponding to FIG. 4 and illustrates the waterproof pad of the vehicle antenna device according to the present disclosure.

FIG. 6 is a schematic enlarged cross-sectional side view for explaining details of another waterproof pad of the vehicle antenna device according to the present disclosure.

### DETAILED DESCRIPTION OF EMBODIMENTS

An embodiment for practicing the present disclosure will be described with illustrated examples. A vehicle antenna device according to the present disclosure is configured such that an antenna element covered with a housing is fixed to a vehicle body. The following describes in detail an example in which the present invention is applied to a low-profile roof-mount antenna device. The present invention is not limited to a roof-mount antenna and not limited in terms of the fixing position as long as an antenna element covered with a housing is fixed to a vehicle, and for example, the invention may also be applied to a dashboard antenna device.

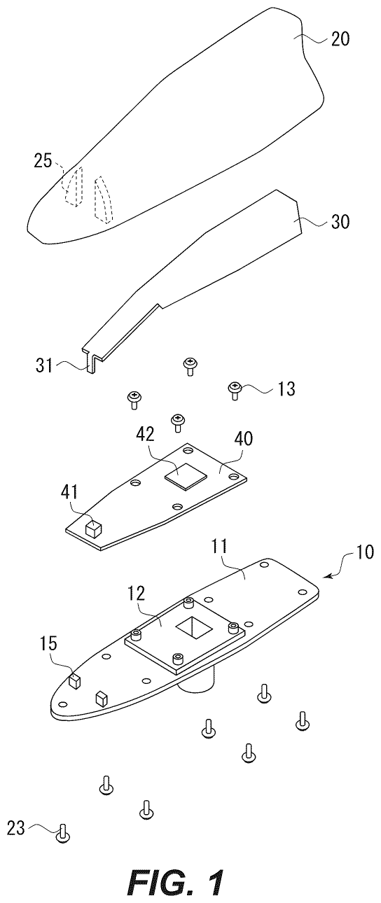

FIG. 1 is a schematic exploded perspective view for explaining the vehicle antenna device according to the present disclosure. As illustrated, the vehicle antenna device according to the present disclosure mainly includes an antenna base 10, an antenna case 20, an antenna element 30, and a circuit board 40. The shapes of the respective components illustrated are merely examples disclosed for the purposes of explanation, and the vehicle antenna device according to the present invention is not limited to such shapes.

The antenna base 10 is composed of a resin base 11 and a conductive base 12 and is a so-called composite antenna base. The illustrated antenna base 10 has a through hole in the central portion of the resin base 11, and the conductive base 12 is configured to be fitted to the through hole. The resin base 11 is fitted to the opening of the antenna case 20 described later so as to close the opening. The resin base 11 and the antenna case 20 may be fixed to each other with screws 23, for example. The conductive base 12 serves as a ground for the circuit board 40 described later. More specifically, the conductive base 12 has a screw boss, which is inserted through a through hole formed in a vehicle roof and is fastened with a nut or the like, so as to be electrically connected to the vehicle roof.

The antenna case 20 is fixed to the antenna base 10 and defines the internal space thereof together with the antenna base 10. The antenna element 30 described later and the circuit board 40 are housed within the internal space of the antenna case 20. The illustrated antenna case 20 has a so-called shark-fin shape. However, the present invention is not limited to this, and the antenna case 20 may have any shape, such as a triangular or quadrangular shape, as long as it has an internal space. Further, the antenna case 20 may have a double-cover structure using inner and outer covers.

The antenna element 30 is disposed within the internal space of the antenna case 20. The antenna element 30 may be, for example, an antenna element for radio reception. The illustrated antenna element 30 is a so-called top-loaded antenna element, which has an umbrella shape. However, the present invention is not limited to this, and the antenna element 30 may have any shape, such as a flat-plate or meander shape, as long as it can function as an antenna element. Further, the antenna element 30 has a feeding section 31. The illustrated feeding section 31 is disposed on the leading end side that is located on the lower-height side of the antenna case 20. However, the present invention is not limited to this, and the feeding section 31 may be disposed at the center or on the rear side of the antenna element 30.

The circuit board 40 is connected with the feeding section 31 of the antenna element 30. The circuit board 40 extends above the conductive base 12 of the antenna base 10 while being fixed thereto and further extends above the resin base 11. That is, the circuit board 40 continuously extends from a position above the conductive base 12 to a position above the resin base 11. The circuit board 40 is fixed to the conductive base 12 with screws 13, for example. The circuit board 40 is electrically connected to the conductive base 12 through the screws 13, for example, whereby the vehicle roof serves as a ground for the circuit board 40. On the other hand, as described below, the circuit board 40 is not fixed to the resin base 11 with the screws 13. That is, when the antenna base 10 is fixed to the antenna case 20, at least a portion of the circuit board 40 extending above the resin base 11 is sandwiched between the resin base 11 and the antenna case 20, whereby the circuit board 40 is fixed.

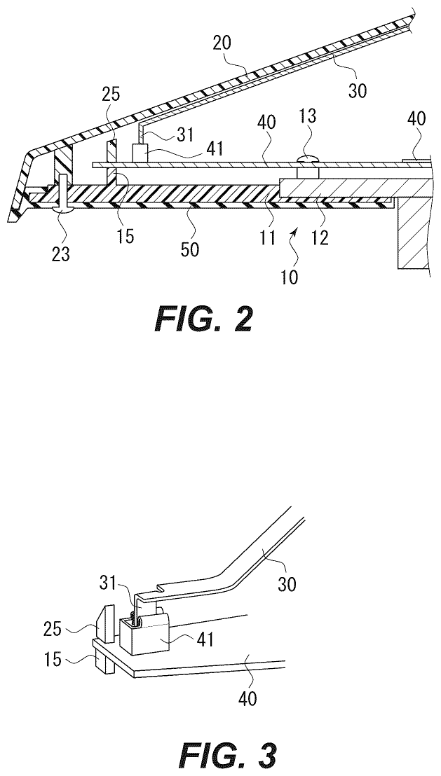

A more specific description will now be given with reference to FIG. 2. FIG. 2 is a schematic enlarged cross-sectional side view for explaining details of the fixed portion of the circuit board included in the vehicle antenna device according to the present disclosure. In the drawing, the same reference numerals as those in FIG. 1 denote the same parts. As illustrated, the antenna case 20 is fixed to the antenna base 10 with the screws 23, for example. At this time, a portion of the circuit board 40 extended above the resin base 11 is sandwiched and held between fixing projections 15 provided on the resin base 11 and fixing ribs 25 provided on the antenna case 20. That is, the front and back surfaces of the circuit board 40 are sandwiched between the fixing projections 15 and the fixing ribs 25, whereby the circuit board 40 is fixed. Since the circuit board 40 is merely sandwiched between the fixing projections 15 and the fixing ribs 25 at its front and back surfaces above the resin base 11, it is slidable in the horizontal direction. On the other hand, above the conductive base 12, the circuit board is fixed to the conductive base 12 with the screws 13 and therefore cannot move in the horizontal direction. Thus, the circuit board 40 is securely fixed to the conductive base 12, whereas it is configured to be slidable above the resin base 11. Thus, even when the resin base 11 and the conductive base 12 differ in thermal expansion coefficient and expand or contract in the horizontal direction due to thermal changes, the circuit board 40 is not subjected to unintended forces caused by thermal stress. When the circuit board 40 above the resin base 11 is fixed at a position where it is configured to be slidable in the longitudinal direction in which the influence of expansion and contraction of the resin base 11 and the conductive base 12 is greater, a further enhanced effect can be achieved.

Although the circuit board 40 is sandwiched between the fixing projections 15 and the fixing ribs 25 in the above illustrated example, the present invention is not limited to this. So long as the circuit board 40 is sandwiched and held between the antenna base 10 and the antenna case 20, it may be sandwiched between projections. Further, the means for fixing the antenna base 10 and the antenna case 20 is not limited to the screws 23, and may also be engagement pawls.

The antenna element 30 may be fixed to the antenna base using a support member or the like. The feeding section 31 of the antenna element 30 may be directly connected to the circuit board 40. Further, the antenna element 30 may be fixed to the antenna case 20. Further, as illustrated in FIG. 2, a connection terminal 41 to which the feeding section 31 of the antenna element 30 is connected may be placed on the circuit board 40.

As described above, in the conventional vehicle antenna devices, the circuit board had to be disposed and fixed only above the conductive base so as to prevent unintended forces caused by thermal stress from being applied thereto. Thus, the connection terminal cannot be disposed on the leading end side that is located on the lower-height side of the antenna case, even if desired, since no circuit board is present there. However, in the vehicle antenna device according to the present disclosure, the circuit board 40 is not subjected to unintended forces caused by thermal stress and therefore may extend to a desired position. Thus, when the antenna case 20 has, for example, a shark-fin shape, the circuit board 40 may extend to a position adjacent to the leading end side that is located on the lower-height side of the shark-fin shaped antenna case 20. This allows the connection terminal 41 to be placed on a portion of the circuit board 40 within the internal space adjacent to the leading end side that is located on the lower-height side of the shark-fin shape. As a result, the layout of the circuit board 40 is subject to less restriction.

Further, an amplifier circuit 42 may be placed on the circuit board 40. The amplifier circuit 42 requires a ground and is therefore preferably placed on a portion of the circuit board 40 extended above the conductive base 12. Since the ground of the circuit board 40 is electrically connected to the conductive base 12, the amplifier circuit 42 is preferably placed at a position around the conductive base 12. In this case, the connection terminal 41 is disposed at a position adjacent to the leading end side that is located on the lower-height side of the shark-fin shape, and the amplifier circuit 42 is disposed on a portion of the circuit board 40 located above the conductive base 12 and covered with the antenna element 30.

Next, the details of the feeding section of the antenna element and the connection terminal in the vehicle antenna device according to the present disclosure will be described using FIG. 3. FIG. 3 is a schematic enlarged perspective view for explaining details of the feeding section of the antenna element and the connection terminal in the vehicle antenna device according to the present disclosure. In the drawing, the same reference numerals as those in FIG. 1 denote the same parts. Also, only the portion around the feeding section 31 and the connection terminal 41 is illustrated, with other components omitted for clarity. The feeding section 31 of the antenna element 30 may be formed of a plate-like terminal having a flat portion, for example. In this case, as illustrated, it may be configured such that the surface direction of the flat portion of the plate-like terminal is oriented in the axial direction passing from the leading end side that is located on the lower-height side of the shark-fin shape to the rear end thereof. The connection terminal 41 may be formed of a leaf spring terminal configured to hold the surface of the flat portion of the plate-like terminal. That is, the groove of the connection terminal 41 that holds the plate-like terminal is also oriented in the axial direction passing from the leading end side that is located on the lower-height side of the shark-fin shape to the rear end thereof. The plate-like terminal of the feeding section 31 is sandwiched by the connection terminal 41 as the leaf spring terminal so as to be slidable in the longitudinal direction of the antenna base 10.

As illustrated in FIG. 3, the connection terminal 41 is thus configured to allow the feeding section 31 to be slidable in the longitudinal direction of the antenna base 10, so that even when the resin base 11 or the conductive base 12 expands or contracts in the longitudinal direction in which the influence of thermal changes is great and thereby causes the position of the circuit board 40 to be displaced relative to the antenna element 30 fixed to the antenna case 20, it is possible to prevent contact failure due to application of unintended forces caused by thermal stress. That is, such unintended forces can by no means be applied between the feeding section 31 and the connection terminal 41. On the other hand, the circuit board 40 is sandwiched between the fixing projections 15 and the fixing ribs 25 above the resin base 11 and is therefore fixed in a stable manner at least in the vertical direction. This prevents the circuit board 40 from sliding in the vertical direction between the feeding section 31 and the connection terminal 41.

The vehicle antenna device according to the present disclosure may further have a waterproof pad 50, as illustrated in FIG. 2. The waterproof pad 50 is interposed between the antenna base 10 and the antenna case 20 so as to ensure waterproofness within the internal space and between the vehicle roof and the antenna base 10. The waterproof pad 50 is configured to cover the bottom surface of (vehicle roof side surface) of the antenna base 10 and to extend from the side portion of the antenna base 10 up to the portion abutting the antenna case 20. That is, it is only necessary for the waterproof pad 50 to cover the antenna base 10.

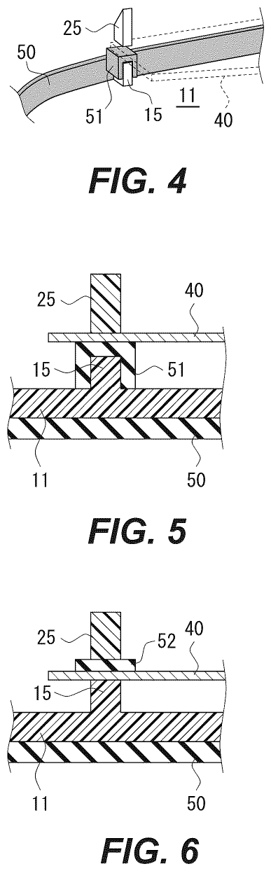

The waterproof pad 50 may be partially interposed between the resin base 11 and the circuit board 40. FIG. 4 is a schematic enlarged perspective view for explaining details of the waterproof pad of the vehicle antenna device according to the present disclosure, and FIG. 5 is a schematic enlarged cross-sectional side view corresponding to FIG. 4 and illustrates the waterproof pad of the vehicle antenna device according to the present disclosure. In the drawings, the same reference numerals as those in FIG. 2 denote the same parts. Only the portion around the fixing projection 15 and the fixing rib 25 is illustrated, with other components omitted for clarity. As illustrated, a portion of the waterproof pad 50 serves as a spacer part 51 that covers the fixing projection 15. That is, the spacer part 51 of the waterproof pad 50 is interposed between the fixing projection 15 of the resin base 11 and the circuit board 40 at the position where the circuit board 40 is sandwiched between the fixing projection 15 of the resin base 11 and the fixing rib 25 of the antenna case 20. With this configuration, even if a dimensional variation exists in the gap for sandwiching the circuit board 40 between the fixing projection 15 and the fixing rib 25, the variation can be absorbed by the spacer part 51.

FIG. 6 is a schematic enlarged cross-sectional side view for explaining details of another waterproof pad of the vehicle antenna device according to the present disclosure. In the drawing, the same reference numerals as those in FIG. 2 denote the same parts. Only the portion around the fixing projection 15 and the fixing rib 25 is illustrated, with other components omitted for clarity. As illustrated, in this example, a spacer part 52 of the waterproof pad 50 is interposed between the fixing rib 25 of the antenna case 20 and the circuit board 40 at the position where the circuit board 40 is sandwiched between the fixing projection 15 of the resin base 11 and the fixing rib 25 of the antenna case 20. In this case, the spacer part 52 may be configured to extend from, for example, the side end portion of the circuit board 40 to the upper surface thereof. For example, after the circuit board 40 is fixed to the antenna base 10, the waterproof pad 50 is disposed so as to cover the antenna base 10. At this time, the spacer part 52 is disposed at the position on the upper surface of the circuit board 40 that is sandwiched between the fixing projection 15 and the fixing rib 25. With this configuration as well, even if a dimensional variation exists in the gap for sandwiching the circuit board 40 between the fixing projection 15 and the fixing rib 25, the variation can be absorbed by the spacer part 52. The spacer part 51 illustrated in FIG. 5 and the spacer part 52 illustrated in FIG. 6 may be combined. That is, it may be configured such that the waterproof pad 50 is partially interposed both between the resin base 11 and the circuit board 40 and between the antenna case 20 and the circuit board 40.

The vehicle antenna device according to the present invention is not limited to the above examples, but may be variously modified within the scope of the present invention.

1. A vehicle antenna device to be fixed to a vehicle body, the vehicle antenna device comprising:
an antenna base having a resin base and a conductive base;
an antenna case that is fixed to the antenna base and defines an internal space thereof together with the antenna base;
an antenna element that is disposed within the internal space of the antenna case and has a feeding section; and
a circuit board to which the feeding section of the antenna element is connected, the circuit board extending above the conductive base while being fixed thereto and further extending above the resin base, wherein, when the antenna base is fixed to the antenna case, at least a portion of the circuit board extended above the resin base is sandwiched between the resin base and the antenna case, to thereby fix the circuit board.

2. The vehicle antenna device according to claim 1, further comprises
a connection terminal that is disposed on a portion of the circuit board extended above the resin base of the antenna base and to which the feeding section of the antenna element is connected.

3. The vehicle antenna device according to claim 2, wherein
the antenna case has a shark-fin shape, and
the connection terminal is disposed on a portion of the circuit board within the internal space adjacent to the leading end side that is located on the lower-height side of the shark-fin shape.

4. The vehicle antenna device according to claim 3, further comprises
an amplifier circuit that is disposed on a portion of the circuit board extended above the conductive base of the antenna base.

5. The vehicle antenna device according to claim 4, wherein
the antenna element is fixed to the antenna case.

6. The vehicle antenna device according to claim 5, wherein
the feeding section of the antenna element is formed of a plate-like terminal having a plate-like flat portion, and a surface direction of the flat portion of the plate-like terminal is oriented in the axial direction passing from the leading end side that is on the lower-height side of the shark-fin shape to the rear end thereof, and
the connection terminal is formed of a leaf spring terminal configured to hold a surface of the flat portion of the plate-like terminal.

7. The vehicle antenna device according to claim 1, further comprises:
a waterproof pad that is interposed between the antenna base and the antenna case so as to ensure waterproofness within the internal space,
wherein the waterproof pad is partially interposed both between the resin base and the circuit board and/or between the antenna case and the circuit board at a position where at least a portion of the circuit board is sandwiched between the resin base and the antenna case.

8. The vehicle antenna device according to claim 2, further comprises:
a waterproof pad that is interposed between the antenna base and the antenna case so as to ensure waterproofness within the internal space,
wherein the waterproof pad is partially interposed both between the resin base and the circuit board and/or between the antenna case and the circuit board at a position where at least a portion of the circuit board is sandwiched between the resin base and the antenna case.

9. The vehicle antenna device according to claim 3, further comprises:
a waterproof pad that is interposed between the antenna base and the antenna case so as to ensure waterproofness within the internal space,
wherein the waterproof pad is partially interposed both between the resin base and the circuit board and/or between the antenna case and the circuit board at a position where at least a portion of the circuit board is sandwiched between the resin base and the antenna case.

10. The vehicle antenna device according to claim 4, further comprises:
a waterproof pad that is interposed between the antenna base and the antenna case so as to ensure waterproofness within the internal space,
wherein the waterproof pad is partially interposed both between the resin base and the circuit board and/or between the antenna case and the circuit board at a position where at least a portion of the circuit board is sandwiched between the resin base and the antenna case.

11. The vehicle antenna device according to claim 5, further comprises:
a waterproof pad that is interposed between the antenna base and the antenna case so as to ensure waterproofness within the internal space,
wherein the waterproof pad is partially interposed both between the resin base and the circuit board and/or between the antenna case and the circuit board at a position where at least a portion of the circuit board is sandwiched between the resin base and the antenna case.

12. The vehicle antenna device according to claim 6, further comprises:
a waterproof pad that is interposed between the antenna base and the antenna case so as to ensure waterproofness within the internal space,
wherein the waterproof pad is partially interposed both between the resin base and the circuit board and/or between the antenna case and the circuit board at a position where at least a portion of the circuit board is sandwiched between the resin base and the antenna case.
